(19) United States
(12) Patent Application Publication
(10) Pub. No.: US 2024/0394772 A1
(43) Pub. Date: Nov. 28, 2024

(54) SYSTEM AND METHOD FOR REAL-TIME DISCOVERY OF RELATED PRODUCTS IN MEDIA CONTENT VIA DEEP LEARNING

(71) Applicant: YAHOO ASSETS LLC, New York, NY (US)

(72) Inventors: James Liao, New Taipei City (TW); Tim Lee, New Taipei City (TW); Alex Ou, New Taipei City (TW); Bryan Suen, Taipei (TW); Chia-Hsin Ting, Taipei City (TW)

(21) Appl. No.: 18/321,480

(22) Filed: May 22, 2023

(51) Int. Cl. G06Q 30/0601; G06F 40/284; G06F 40/30; G06N 3/08

(52) U.S. Cl. CPC G06Q 30/0631; G06F 40/284; G06F 40/30; G06N 3/08; G06Q 30/0625

(57) ABSTRACT

The present teaching relates to method, system, medium, and implementations for product recommendation. For each media article, it is determined whether the media article corresponds to commerce content. If so, the media article may be combined with information about a product promoted in the media article to generate combined content. An integrated content to be sent to the user is generated to include combined content for each media article that is commerce content and each media article that is not commerce content. Such integrated content is then sent to the user.

### BACKGROUND

### 1. Technical Field

The present teaching generally relates to computers. More specifically, the present teaching relates to data analytics and application thereof.

### 2. Technical Background

With the advancement of the Internet, many activities of members of the society are now conducted online, including consumption of content, product reviews and purchases, entertainment, or education. Content made available online encompasses different fields and many overlap. For instance, a media article on local news reporting the grant opening of a new site for assembling smart phones may include, e.g., a description about the particular smart phone to be manufactured at the new site, various features of the smart phone, as well as a comparison of various features of the smart phone with other competing products. Although the media article is intended to report the opening of a workplace in the locale, it also incorporates the content related to the specifics of the smart phone to be made locally and competing products and their features. In some situations, such a media article may even include links to website where a reader may purchase any of the products mentioned in the article.

A reader who is reading such a media article may receive information about the local news as well as some information about some products. In some situations, when links to mentioned products are provided, the reader may even make a purchase of one of the products mentioned by following the link(s) provided in the media article. In today's society, online purchases constitute a sizeable volume in commerce. Revenue of companies that host and provide content to online users (such as content portals or search engine) may also significantly be impacted on the volume of sales achieved via links in content they provided to users to product sale websites. As such, it is important to provide as much information as possible on products described in media articles to readers to encourage commercial activities. Unfortunately, many media articles having content related to some products may not present the potential to be leveraged to allow monetization. For example, a media article may not provide necessary information (e.g., a link to a site to sell the product) to lead to meaningful commercial activities. As another example, a media article may mention a category of product (e.g., smart phone) without any specifics to link to any brand or manufacturer, making it impossible to gather useful information on a product to user to motivate further. Another issue is that whatever information a media article provides (such as a link) may have become stale due to passage of time, also making it impossible to lead a reader to a correct site even if the reader is interested. There may be other situations where media articles fail to facilitate user's commerce activities to realize the commercial potential of the articles.

Thus, there is a need for a solution that addresses the issues discussed above.

### SUMMARY

The teachings disclosed herein relate to methods, systems, and programming for information management. More particularly, the present teaching relates to methods, systems, and programming related to hash table and storage management using the same.

In one example, a method, implemented on a machine having at least one processor, storage, and a communication platform capable of connecting to a network for product recommendation. For each media article, it is determined whether the media article corresponds to commerce content. If so, the media article may be combined with information about a product promoted in the media article to generate combined content. An integrated content to be sent to the user is generated to include combined content for each media article that is commerce content and each media article that is not commerce content. Such integrated content is then sent to the user.

In a different example, a system is disclosed for product recommendation, that includes a content search engine and a product/content integrator. The content search engine is configured for search for media articles, either based on a user query or for content recommendation to a user. The product content integrator is configured for, with respect to each media article, determining whether the media article corresponds to commerce content. If so, the media article may be combined with information about a product promoted in the media article to generate combined content. An integrated content to be sent to the user is then generated to include combined content for each media article that is commerce content and each media article that is not commerce content. Such integrated content is then sent to the user.

Other concepts relate to software for implementing the present teaching. A software product, in accordance with this concept, includes at least one machine-readable non-transitory medium and information carried by the medium. The information carried by the medium may be executable program code data, parameters in association with the executable program code, and/or information related to a user, a request, content, or other additional information.

Another example is a machine-readable, non-transitory and tangible medium having information recorded thereon for product recommendation. The information, when read by the machine, causes the machine to perform various steps. For each media article, it is determined whether the media article corresponds to commerce content. If so, the media article may be combined with information about a product promoted in the media article to generate combined content. An integrated content to be sent to the user is generated to include combined content for each media article that is commerce content and each media article that is not commerce content. Such integrated content is then sent to the user.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A depicts an exemplary framework for media content based commerce via a content/product service engine, in accordance with an embodiment of the present teaching;

FIG. 1B illustrates an exemplary archive for media articles with metadata, in accordance with an embodiment of the present teaching;

FIG. 2A depicts an exemplary high level system diagram of a content/product service engine, in accordance with an embodiment of the present teaching;

FIG. 2B is a flowchart of an exemplary process of a content/product service engine, in accordance with an embodiment of the present teaching;

FIG. 3A depicts an exemplary high-level system diagram of a commerce content detector for recognizing commerce content, in accordance with an embodiment of the present teaching;

FIG. 3B is a flowchart of an exemplary process of a commerce content detector for recognizing commerce content, in accordance with an embodiment of the present teaching;

FIG. 3C is a flowchart of an exemplary process of generating a shopping intention model used in recognizing commerce content, in accordance with an embodiment of the present teaching;

FIG. 4A shows an example media article without shopping intention, in accordance with an embodiment of the present teaching;

FIG. 4B shows an example media article with detected shopping intention to qualify as commerce content, in accordance with an embodiment of the present teaching;

FIG. 5A depicts an exemplary high level system diagram of a product keyword extractor, in accordance with an embodiment of the present teaching;

FIG. 5B shows a visual example of a process of identifying product keywords from a media article, in accordance with an embodiment of the present teaching;

FIG. 5C is a flowchart of an exemplary process of a product keyword extractor, in accordance with an embodiment of the present teaching;

FIG. 6A depicts an exemplary high-level system diagram of a keyword-based P-source search engine, in accordance with an embodiment of the present teaching;

FIG. 6B illustrates example product sources identified via product keyword based search and commercial performance measures associated therewith, in accordance with an embodiment of the present teaching;

FIG. 6C is a flowchart of an exemplary process of a keyword-based P-source search engine, in accordance with an embodiment of the present teaching;

FIG. 6D is a flowchart of an exemplary process for continually updating the performance statistics for different product sources, in accordance with an embodiment of the present teaching;

FIG. 7 is an illustrative diagram of an exemplary mobile device architecture that may be used to realize a specialized system implementing the present teaching in accordance with various embodiments; and

FIG. 8 is an illustrative diagram of an exemplary computing device architecture that may be used to realize a specialized system implementing the present teaching in accordance with various embodiments.

### DETAILED DESCRIPTION

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

The present teaching discloses an exemplary framework for serving online media articles (content) with product information to monetize media articles in a manner that is relevant, up to date, and content-appropriated. Content commerce drives users from media to e-commerce. In content commerce, media articles used to promote e-commerce products are defined as commerce content. There may be different categories of commerce content. The first category may include media articles provided to promote some specific e-commerce marketplace and this type of media articles frequently embed products in its content and some provide directly links that transfer users to the e-commerce sites that sell the products. In some situations, the links provided may no longer operational. The second category of media articles may be those that promote specific products with detailed description of the promoted products such as brands, models, etc. but without providing links to online sale sites. Users of such media articles need to search themselves to identify information about such sale sites, making it more difficult for users and less effective in monetization. A third category of commerce content may promote generally some type of products (e.g., smart phone) without promoting any specific product of the type.

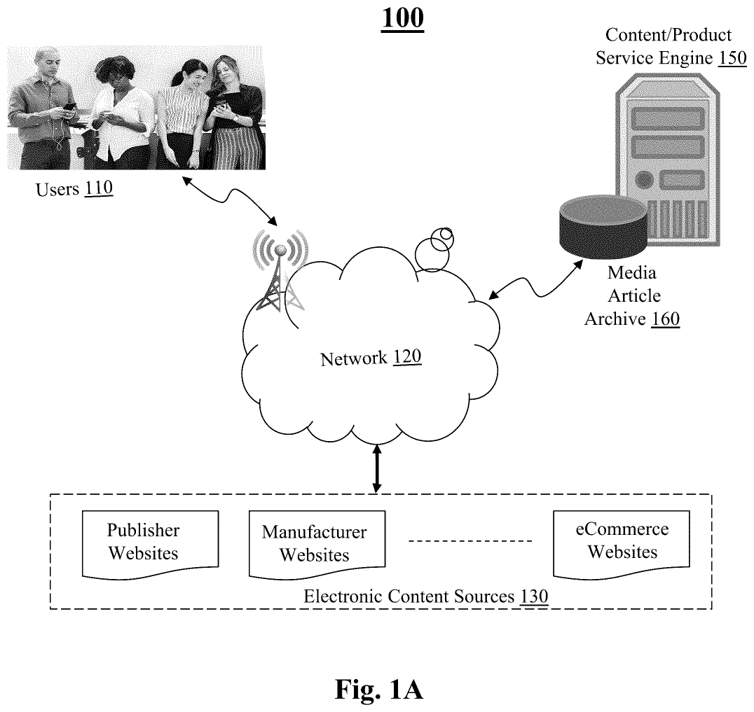

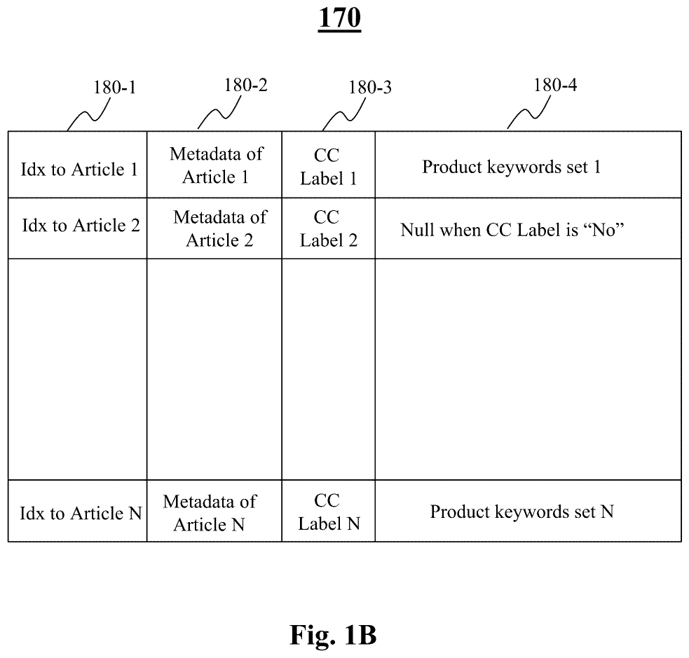

The present teaching aims to enhance effectiveness of monetizing commerce content by automatically recognizing commerce content, identifying relevant product(s) embedded in the commerce content, discovering the latest and most up-to-date information about the embedded products in accordance with the context of the commerce content, and serving the product information to users who requested the commerce content. Such automatically provided to users with the commerce content facilitates users to readily access relevant and up-to-date product information with easy activation of links to e-commerce sites that supports online transactions. Details of the present teaching related to different aspects are disclosed below with reference to FIGS. 1A-6B.

FIG. 1A depicts an exemplary framework 100 for media content based commerce via a content/product service engine 150, in accordance with an embodiment of the present teaching. In this illustrated embodiment, the framework 100 connects, via network connection 120, different parties to effectuate services. Such parties include users 110, various electronic content sources 130, and a content/product service engine 150. The electronic content sources 130 may include different sources from where electronic content may be obtained, such as publisher websites, manufacturer websites, merchants' websites, websites of different online interest groups, social media platforms, . . . , and e-Commerce websites. The content/product service engine 150 may recommend to users or search content for users based on queries. The content/product service engine 150 may correspond to a content portal, a search engine, a social media platform operator, or any party that provides content related services.

The content/product service engine 150 may have its own content pool such as a media article archive 160 that stores media articles or content that the content/product service engine 150 may have curated, searched, or accessed from different electronic content sources. In the media article archive 160, media articles may be organized in terms of categories and types with certain meta information to specify the same. For example, the media article archive 160 may organize media articles into different categories, including commerce content and non-commerce content categories. For each of the media articles that has been classified as commerce content, it may be labeled as such and archived in conjunction with the product information discovered by the content/product service engine 150 therefor. In providing content services, when a media article searched based on a user's query corresponds to a commerce content, the product information discovered for the media article on a product embedded in the commerce content may be provided to the user together with media article that are recognized as commerce content.

FIG. 1B illustrates an exemplary meta data construct 170 for archiving media articles with meta information therein, in accordance with an embodiment of the present teaching. In this illustrated embodiment, in addition to stored media articles, the media article archive 160 may provide meta data construct 170 as shown in FIG. 1B with each row corresponding to a corresponding media article. Each row for a specific media article may include an index 180-1 pointing to a storage location where the media article is stored, meta data about the article 180-2 (e.g., publication date, author, taxonomy, etc.), a class classification (CC) label 180-3 on whether the media article is commerce content, and product keywords 180-4 if the media article is commerce content. When the CC label for a media article indicates that it is a non-commerce label, then there will be no product keyword associated with the media article.

The network 120 as illustrated in FIG. 1 may be a local area network (LAN), a wide area network (WAN), a public network, a private network, a proprietary network, a Public Telephone Switched Network (PSTN), the Internet, a wireless network, a virtual network, or any combination thereof. Such a network or any portions thereof may be a 4G network, a 5G network, or a combination thereof. The network 120 may also include various network access points, e.g., wired, or wireless access points such as base stations or Internet exchange points, through which a particular customer may connect to the network in order to provide and/or transmit information to a specific destination. The information communicated among users 110 and the content/product service engine 150 via the network 120 may be delivered as bitstreams which may be encoded in accordance with certain industrial standards, such as MPEG4 or H.26x, and the network may be configured to support the transport of such encoded data streams.

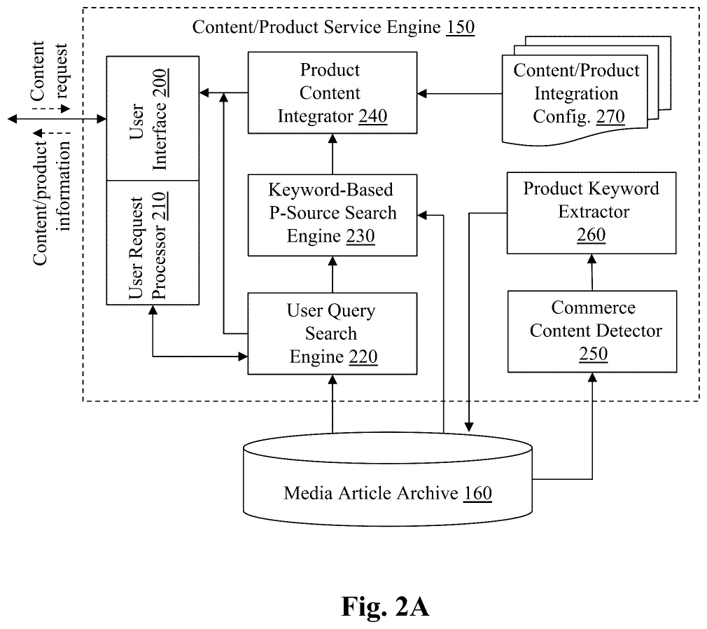

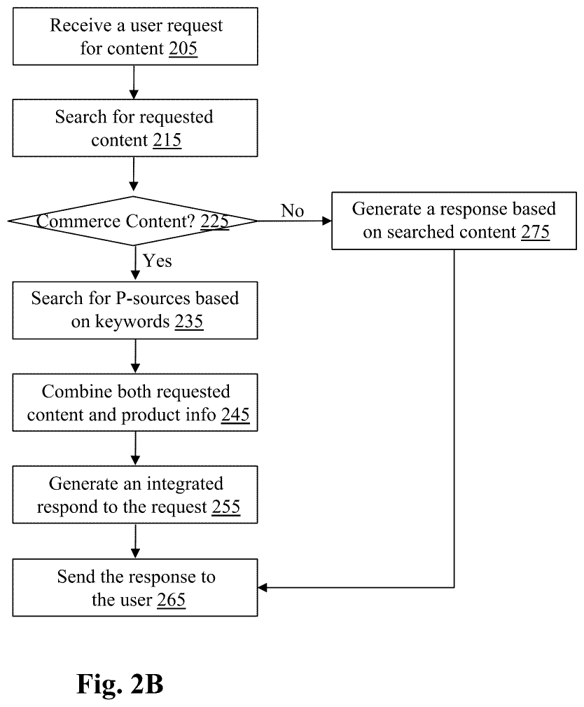

FIG. 2A depicts an exemplary high level system diagram of the content/product service engine 150, in accordance with an embodiment of the present teaching. In this illustrated embodiment, the content/product service engine 150 comprises two portions, one corresponding to backend processing and the other corresponding to frontend operation. The backend portion may include a commerce content detector 250 and a product keyword extractor 260. The backend portion may be for processing the media articles archived in 160 to automatically detecting commerce content label each as such. As discussed herein, media articles that are recognized as commerce content may trigger the content/product service engine 150 to discover product information from different sources and deliver such product information together with the underlying media articles. To facilitate discovery of or search for information related to a product embedded in commerce content, the product keyword extractor 260 may be provided to identify keywords associated with a product embedded in each commerce content to enable the search for sources with product information.

The frontend portion of the content/product service engine 150 is the part that interfaces with users and delivers services. The frontend portion in this illustrated embodiment comprises a user interface 200, a user request processor 210, a user query search engine 220, a keyword-based P-source search engine 230, and a product content integrator 240. The user interface 200 is provided to interact with a user to receive a request for content or deliver media articles with optionally product information (if some media articles correspond to commerce content). The user request processor 210 is provided to process a request or a query from a user to produce a result to be used by the user query search engine 220 to search, from the media article archive 160, media articles that are relevant to the user's request. As discussed herein, some of the media articles in 160 may be classified as commerce content and are marked as such, which may be provided to the user as a response together with information about the product(s) promoted by the commerce content.

The keyword-based P-source search engine 230 may be provided to search for sources of product information (websites with more detailed information about a product and support for purchase of the product) based on keywords associated with the product promoted by the commerce content. The product content integrator 240 may be provided for integrating a media article (content) with information about a product promoted by the media article for, e.g., simultaneous delivery to the user. Such integration may relate to how to present the content and the product information to the user. For example, the sources that sell a product promoted by a media article may be presented in a popup window while the media article is displayed to the user. Another example may be to integrate a media article with product information so that when the media article is displayed to a user, when the user interested in the product and use a mouse to hover over the text mentioning the product, the product information (e.g., sources that sell the product) may be displayed next to the mouse. The specification of the mechanism of integrating a media article and information of a product promoted by the article may be generated by the product content integrator 240 according to a pre-configured content/product integration configuration 270 and provided to the user interface 200 for delivery to the user.

FIG. 2B is a flowchart of an exemplary process of the content/product service engine 150, in accordance with an embodiment of the present teaching. When the user interface 200 receives, at 205, a user request for content (media articles), the user request processor 210 processes the request and the processed result is used by the user query search engine 220 to search, at 215, media articles from the media article archive 160 that are relevant to the user's request (e.g., user request content from a certain author on a field identifiable based on taxonomy of the media articles). With respect to each of the media articles matching the user's query, it is determined, at 225, whether the media article is classified as commerce content. If the media article is classified as non-commerce content, the user query search engine 220 generates, at 275, a response based on the searched media article and provides the response to the user interface 200, which is then sent, at 265, the response to the user.

If the media article is classified as commerce content, the keyword-based P-source search engine 230 is invoked to retrieve the product keywords from the media article archive 160 and then search, at 235, product sources associated with the product (P-sources) based on retrieved keywords identified from the media article (see FIG. 1B for the exemplary media articles' meta data construct 170). The discovered P-sources may then be provided to the product content integrator 240, where the media article and the information related to the discovered P-sources are combined, at 245, to generate, at 255, an integrated response to the user's request. The product content integrator 240 then provides the integrated response to the user interface 200, which then sends, at 265, the integrated response to the user.

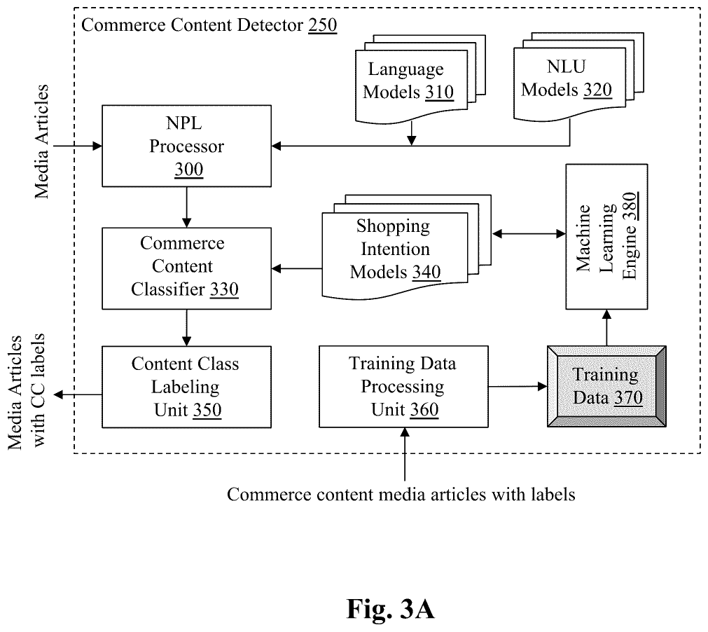

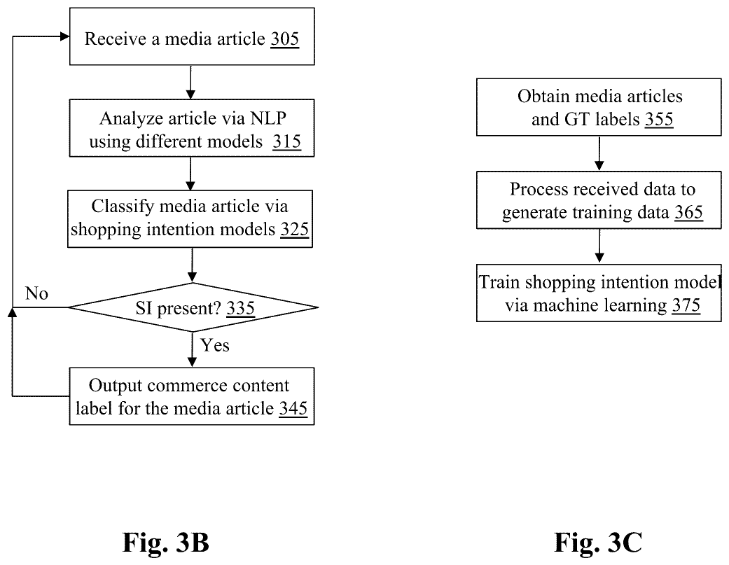

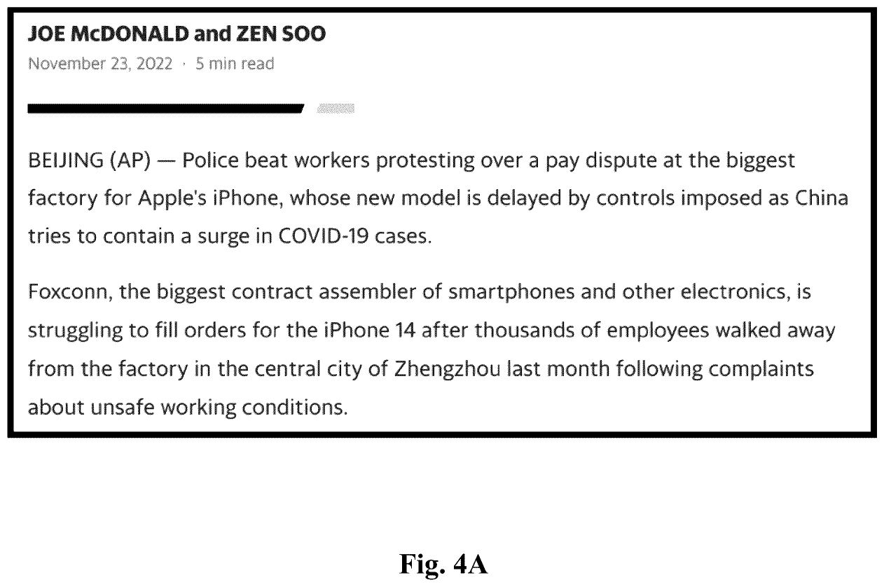

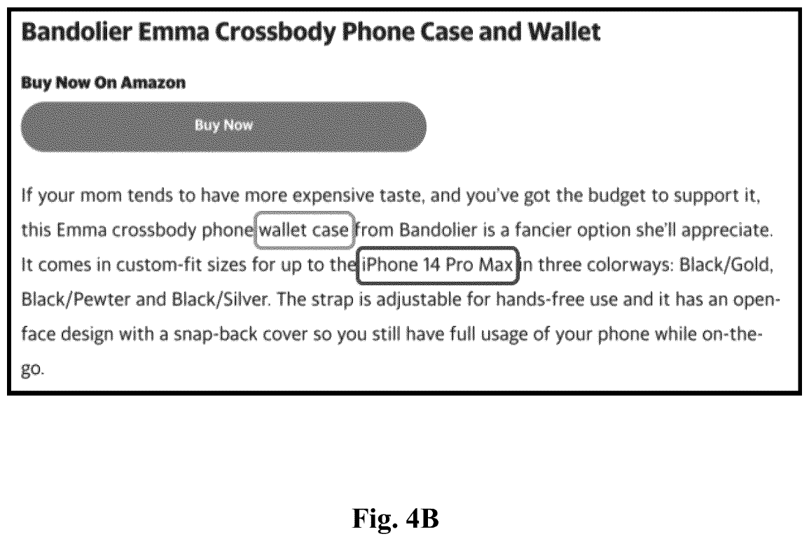

FIG. 3A depicts an exemplary high-level system diagram of the commerce content detector 250 for recognizing commerce content, in accordance with an embodiment of the present teaching. As discussed herein, the content/product service engine 150 has a backend portion provided for processing media articles and classifying, based on the processing results, them into commerce or non-commerce content. This may be important because some media articles are not intended to promote any product, either generally or specifically, so that it may not be appropriate to provide commercial motivated information about a product to a reader of such media articles. FIG. 4A shows an example media article that, although with a mention of some product, does not qualify as commerce content, in accordance with an embodiment of the present teaching. The media article as presented herein reports that workers at an assembly factory for iPhone 14 walked away from the factory due to COVID-19. In this case, although a specific product name (iPhone 14) is mentioned in the media article, it is an article generally read by an audience who is likely not in a mindset of exploring products from such an article. That is, this media article is not promoting a product and thus does not qualify as commerce content.

To process media articles archived in 160 to classify each as to whether it is commerce content, the commerce content detector 250, as illustrated in FIG. 3A, comprises a natural language processing (NLP) processor 300, a commerce content classifier 330, a content class labeling unit 350, an input data processing unit 360, and a machine learning engine 380. According to the present teaching, whether a media article qualifies as commerce content may be determined by examining whether the media article has so called shopping intention, based on shopping intention models 340, as shown in FIG. 3A. When a media article is retrieved, the NLP processor 300 analyzes the media article based on language models 310 and natural language understanding models 320. Based on the language analysis result, the commerce content classifier 330 may determine whether the media article corresponds to commerce content based on shopping intention models 340. Once the decision is made as to commerce content, the content class labeling labelling unit 350 writes the CC label for the media article into the corresponding row for the media article in the meta data construct 170.

As illustrated, the classification of commerce content is keyed on whether there is shopping intention, modeled by the shopping intention models 340. Shopping intention models 340 may be learned, via the machine learning engine 380 based on training data 370, created by the input data processing unit 360 based on input data on commerce content media articles with ground truth CC labels. As illustrated in FIG. 4A that a media article reporting a walk-out from an iPhone 14 assembly factory is not commence content because it is not intended for promoting product iPhone 14. That is, the media article as presented in FIG. 4A does not exhibit shopping intention.

FIG. 4B shows another example media article that qualifies as commerce content as it exhibits shopping intention, in accordance with an embodiment of the present teaching. In this media article provided in FIG. 4B, names of two products are mentioned, i.e., “wallet case” and “iPhone 14 Pro Max.” An analysis of the content of the article may reveal that it does promote some product with an intent to encourage a reader to shop. That is, it may possess shopping intention and thus qualifies as commerce content. In some situations, a media article may mention more than one product and there may be a question as to which product the article is promoting. In this example article in FIG. 4B, based on the content of the article, what the article is promoting is “wallet case” rather than “iPhone 14 Pro Max.” Although both product names are mentioned, the similarity between a taxonomy classification of the article and that of the product name may be used to determine which product is the one that the article is promoting. In this example, the content of the article may be classified into taxonomy “fashion.” As the taxonomy classification of “wallet case” is the same as that of the article, “wallet case” may be considered as a product that the media article is trying to promote. However, as the taxonomy classification of “iPhone 14 Pro Max” may be “technology,” which is inconsistent with the taxonomy class of the media article “fashion” or at least less similar to “fashion” than “wallet case,” it may be deemed that this media article is promoting a “wallet case” product.

FIG. 3B is a flowchart of an exemplary process of the commerce content detector for recognizing commerce content, in accordance with an embodiment of the present teaching. In operation, when a media article is received, at 305, by the NLP processor 300, the media article is analyzed based on different computational linguistic models such as language models 310 and NLU models 320. Based on the NLP results and the shopping intention models 340, the commerce content classifier 330 classifies, at 325, the media article. If the media article is classified as without shopping intention, determined at 335, the process continues to process the next media article, e.g., without writing a CC label to the meta data construct 170 (e.g., the CC labels may be initialized to be corresponding to non-commerce content). If the media article does possess shopping intentions, the media article is considered commerce content and a CC label reflecting the same is output, at 345, to populate the CC label of the row for the media article. The process then returns to 305 to process the next media article.

FIG. 3C is a flowchart of an exemplary process of generating shopping intention models 340 vi machine learning, in accordance with an embodiment of the present teaching. The input data processing unit 360 receives, at 355, input data which may include media articles with their respective ground truth CC labels, it processes, at 365, the input data to create training data 370 for machine learning shopping intentions. In some embodiments, the input data provided for generating training data may include media articles, each of which is associated with a ground truth CC label. Such generated training data are then used by the machine learning engine 380 to conduct training, at 375, the shopping intention models 340.

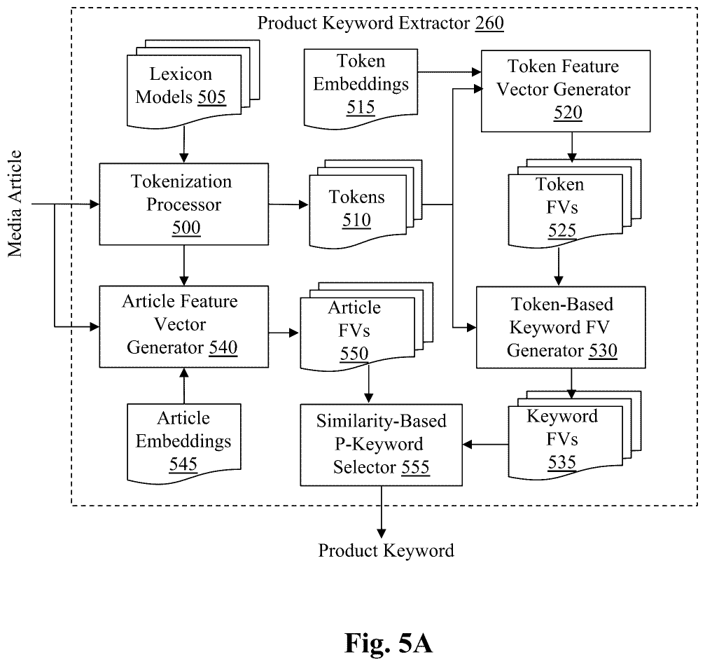

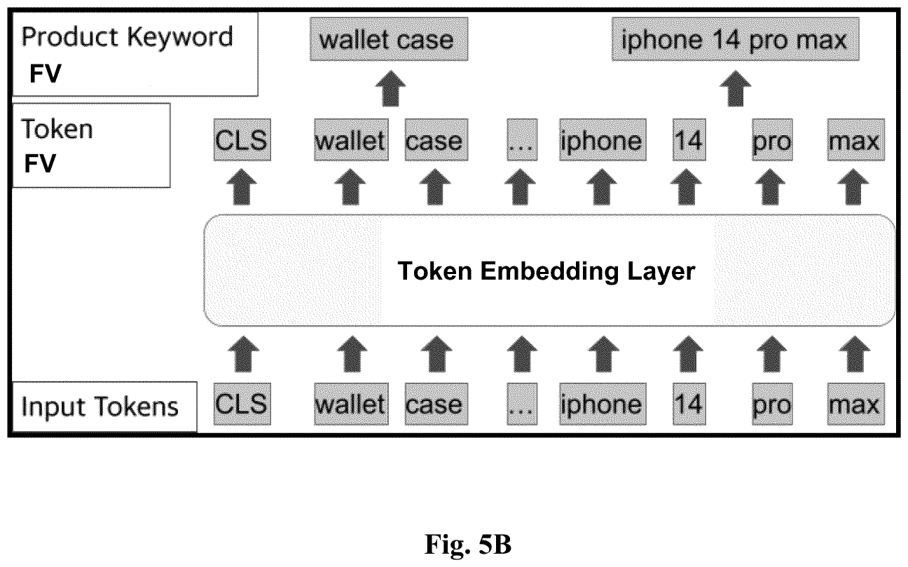

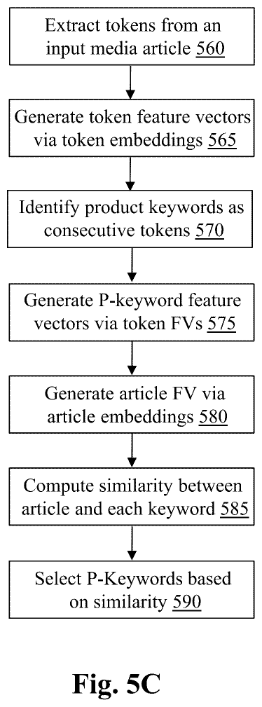

As discussed herein, for a media article that is classified as commerce content, a product that is promoted by the media article and keywords associated therewith need to be identified. Such identification may also address the issue when there are multiple product names mentioned in the media article as shown in FIG. 4B. As briefly mentioned above, an exemplary scheme to select one of the multiple product names mentioned in a media article as the product that article is promoting is based on the affinity between the taxonomy class of the article and that of the product name. FIG. 5A illustrates an exemplary implementation of such a scheme. This illustrated implementation is not intended as a limitation to the present teaching and any other schemes for determining one of multiple product names as relating to the promoted product by the underlying article may also be used and are all within the scope of the present teaching.

FIG. 5A depicts an exemplary high level system diagram of the product keyword extractor 260, in accordance with an embodiment of the present teaching. In this illustrated embodiment, the product keyword extractor 260 comprises a tokenization processor 500, an article feature vector (FV) generator 540. A token feature generator 520, a token-based keyword FV generator 530, and a similarity-based product keyword (P-keyword) selector 555. The tokenization processor 500 is provided for processing a media article to identify tokens 510 from the text based on, e.g., lexicon models 505. Such identified tokens may then be used to construct feature vectors for both the media article and product keywords so that their similarity may be determined. The article feature vector generator 540 is provided for generating feature vectors for articles 550 based on, e.g., article embeddings 545.

With respect to product keyword and feature vectors thereof, the tokens 510 identified from a media article are used by the token feature vector generator 520 to generate token FVs 525 based on, e.g., token embeddings 515. Such generated token FVs may be used by the token-based keyword FV generator 530 to produce feature vectors for product keywords 535. Based on the article feature vectors 550 as well as product keyword feature vectors 535, the similarity-based product keyword selector 555 selects one of the product keywords extracted from the media article as the product that the media article is promoting. In this illustrated embodiment, both the article feature vector 550 and the token feature vectors 525 are obtained based on pre-trained article embeddings 545 and token embeddings 515, respectively. It is noted that feature vectors for a media article and each of the tokens in the media article may be computed in any other approaches, whether existing today or developed in the future.

FIG. 5B shows a visual illustration of a process of identifying product keywords and their feature vectors based on a media article based on embeddings, in accordance with an embodiment of the present teaching. In this illustrated embodiment, a multi-class classifier may be employed to derive feature vectors of a media article, its tokens, and product keywords based on embeddings. In some embodiments, a Bidirectional Encoder Representations from Transformers (BERT) may be used for multi-class classification. In this exemplary BERT architecture, upon a sequence of tokens are identified as input tokens from a media article (where the input tokens may correspond to word sequence of the media article), through token embeddings in a token embedding layer, token feature vectors may be produced. Based on such token embeddings, product keywords may be identified via classification and corresponding product keyword feature vectors may be derived based on the token feature vectors for tokens forming each product keyword. In some embodiments, a product keyword feature vector may be determined by the mean of the token vectors for the tokens forming the product keyword. For instance, for product keyword “wallet case,” its feature vector may be the average of feature vectors for token “wallet” and “case.”

With respect to the media article, its classification may also be derived based on the illustrated BERT architecture. A media article may belong to one of multiple classes, such as fashion, politics, sports, technology, art, entertainment, etc. A classification for a taxonomy class may also be used as a token. For example, CLS in FIG. 5B represents a classification of the media article so that a feature vector for the CLS of a media article may also be derived based on a trained BERT model.

FIG. 5C is a flowchart of an exemplary process of the product keyword extractor 260, in accordance with an embodiment of the present teaching. When the tokenization processor 500 receives an input media article, it extracts, at 560, tokens 510 from the input media article. The tokens so extracted are used by the token feature generator 520 to generate, at 565, token feature vectors 525 via token embeddings 515. Tokens are then used, by the token-based keyword FV generator 530 to identify, at 570, product keywords as consecutive tokens and generate, at 575, feature vectors 535 for the identified product keywords based on, e.g., the token feature vectors. On the other hand, for the input media article, the article feature vector generator 540 generates, at 580, a feature vector 550 for the input media article based on, e.g., article embeddings 545.

Based on the article feature vector 550 and the product keyword feature vector(s) 535, the similarity-based product keyword (P-keyword) selector 555 computes, at 585, a similarity between the article and each of the product keywords identified from the media article based on their respective feature vectors. That is, if there are three product keywords extracted from the input media article, three similarities are computed. As discussed herein, the similarity between the input media article and a product keyword (based on their respective feature vectors) may measure the affinity in category between the two. A high similarity between the two indicates that the product keyword is supported by the narratives in the media article and, hence, more likely that it is the product promoted by the media article. Based on the computed similarities, the similarity-based P-keyword selector 555 then selects, at 590, a product keyword as the one promoted by the input media article.

As discussed herein, the product keyword extractor 260 is part of the backend processing, as seen in FIG. 1A, and the processing result may be stored back in the media article archive 160, e.g., in the meta data construct 170 as shown in FIG. 1B. What is also stored in the meta data construct 170 includes the CC label with respect to each of the media articles archived in 160. For each media article that is classified as commerce content, the product keywords as identified according to the present teaching may be stored accordingly. As shown in FIG. 1A, in the operation of the frontend portion of the content/product service engine 150, if a media article retrieved from the media article archive 160 based on a user's request corresponds to commerce content (determined based on its CC label), the product keyword(s) stored therewith may be used by the keyword-based p-source search engine 230 to search online for the most relevant and up-to-date source(s) where the user can find additional information about the product and make a purchase if needed.

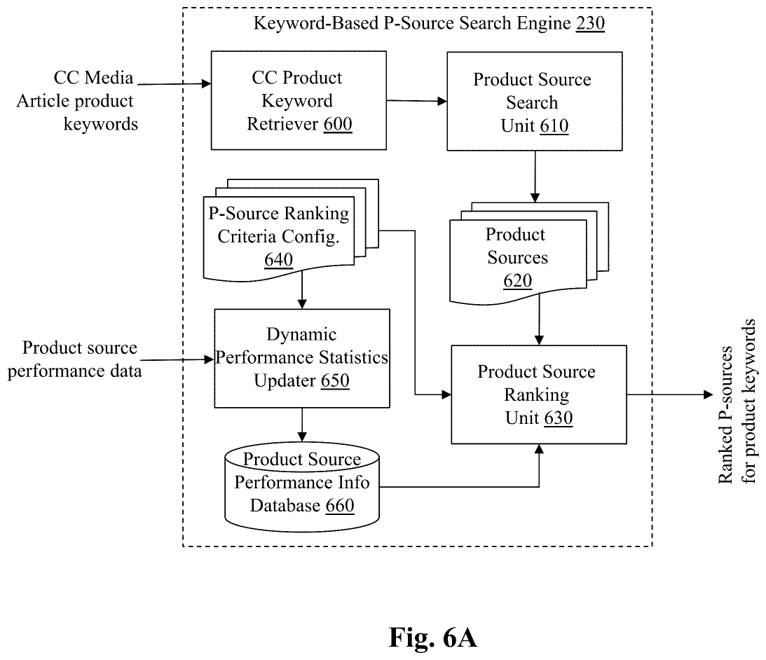

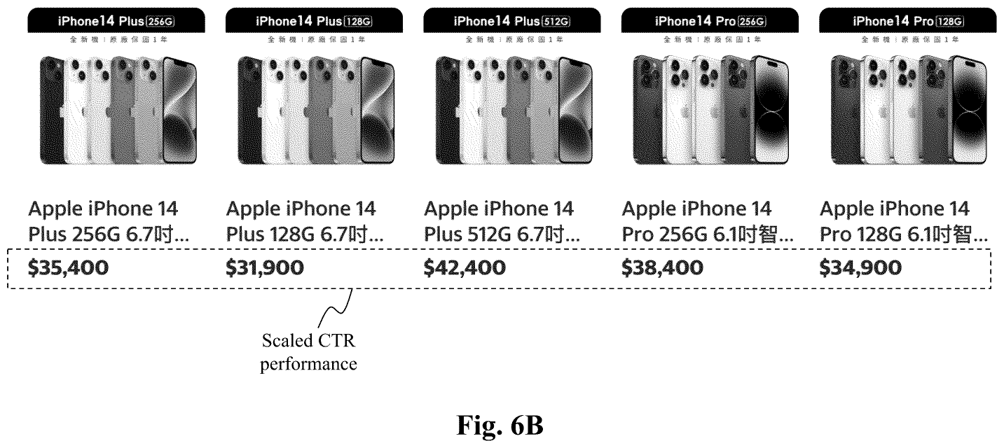

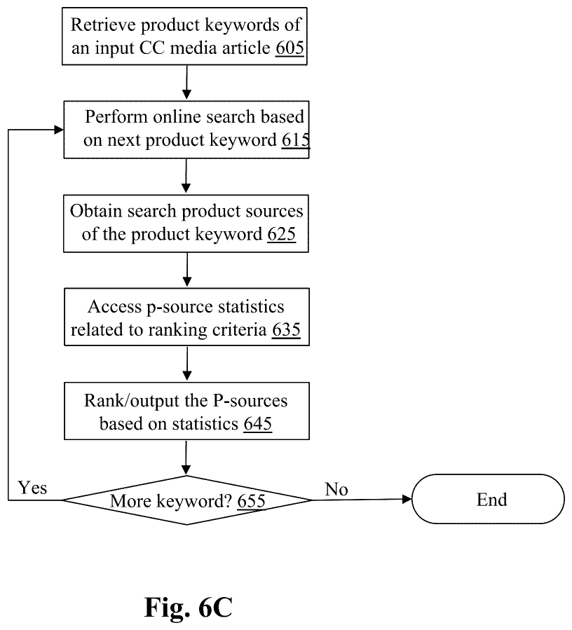

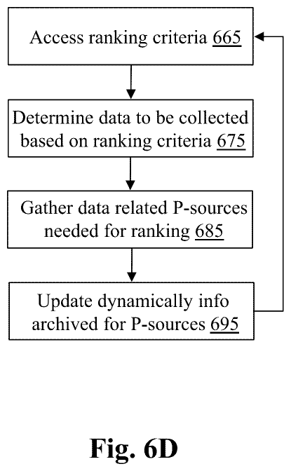

FIG. 6A depicts an exemplary high-level system diagram of the keyword-based P-source search engine 230, in accordance with an embodiment of the present teaching. As there may be many product sources that can be identified based on a product keyword, in some embodiments, the present teaching adopts a two-phase operation, in which the first phase involves keyword based online search and the second phase involves rankings of the online product sources from the first phase and selecting a reasonable number of product sources based on some criterion, e.g., financial performance of each product source. In this illustrated embodiment, the keyword-based p-source search engine 230 includes a CC (commerce content) product keyword retriever 600, a product source search unit 610, a product source ranking unit 630, and a dynamic performance statistics updater 650.

The CC product keyword retriever 600 may be provided for retrieving the product keyword(s) stored in the media article archive 160 with respect to a media article that is currently being processed. The product source search unit 610 may be provided to carry out the first phase of the operation, i.e., using each product keyword to do an online search for all product sources 620 related to the product keyword. The product source ranking unit 630 may be provided for ranking the online product sources 620 based on specified ranking criterion configured in 640. In some embodiments, product sources and their respective statistics describing, e.g., their commercial performances, may be stored in a product source performance info database 660 so that the product source ranking unit 630 may rank the product sources based on the information stored in the product source performance info database 660 and in accordance with the criterion specified in 640.

In some embodiments, the criterion configured in 640 may specify that the performance criterion to be used in ranking product sources may be the click-through rate (CTR) associated with each product source. As CTR may reflect a level of commercial performance associated with a product source, using this measure to rank the product sources may maximize the effect of monetizing the media article. FIG. 6B illustrates example product sources with respective scaled financial performance associated with CTRs. As seen, based on a product keyword “iPhone 14 Plus,” multiple product sources may be identified, each of which is associated with a scaled (e.g., daily) financial performance statistics, which may be used for ranking. To maximize the effect of monetizing a media article that promotes the product “iPhone 14 Plus,” the ranking may be specified to rank different product sources based on the descending order of their scaled financial performance statistics.

To readily access financial performance statistics of different product sources, the dynamic performance statistics updater 650 may be provided to continually collect externally the performance data associated with various product sources and then update the performance statistics stored in the product source performance information database 660. Such dynamically updated performance information associated with various product sources may then be used by the product source ranking unit 630 to rank identified product sources. In some embodiments, after ranking the product sources, the product source ranking unit 630 may also be optionally configured to select K top ranked product sources and output the top K product sources an output.

FIG. 6C is a flowchart of an exemplary process of the keyword-based P-source search engine 230, in accordance with an embodiment of the present teaching. When the CC product keyword retriever 600 receives an indication that the media article currently being processed is a commerce content, it retrieves, at 605, product keyword(s) of the media article from the meta data construct 170 stored in the media article archive 160. Based on each of the retrieved product keyword, the product source search unit 610 performs an online search, at 615, to obtain, at 625, a list of websites that have the product keyword and saves such product sources in 620. Based on the multiple product sources 620 identified via product keyword search, the product source ranking unit 630 accesses, at 635, the ranking criterion specified in 640 and performance statistics of the product sources from 660 accordingly. Based on such accessed information, the product source ranking unit 630 ranks, at 645, the product sources based on the performance statistics in accordance with the ranking criterion. This process repeats for each of the product keywords associated with the media article.

FIG. 6D is a flowchart of an exemplary process of the dynamic performance statistics updater 650 for continually updating the performance statistics for different product sources, in accordance with an embodiment of the present teaching. In operation, the dynamic performance statistics updater 650 accesses, at 665, ranking criterion configured in 640 for ranking different product sources in order to determine, at 675, the performance statistics to be collected to facilitating the ranking operation. The performance statistics may then be obtained, at 685, from external sources (e.g., a third party or from the product sources) in accordance with some schedule, e.g., daily, weekly, or monthly collection schedule. Based on the collected performance statistics, the dynamic performance statistics updater 650 may then update, at 695, the corresponding information stored in the product source performance info database 660.

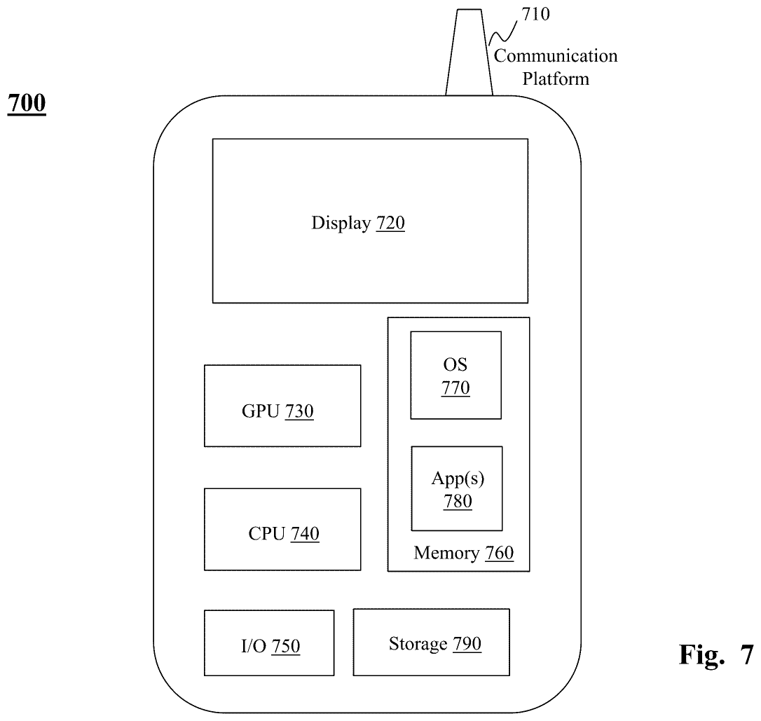

FIG. 7 is an illustrative diagram of an exemplary mobile device architecture that may be used to realize a specialized system implementing the present teaching in accordance with various embodiments. In this example, the user device on which the present teaching may be implemented corresponds to a mobile device 800, including, but not limited to, a smart phone, a tablet, a music player, a handled gaming console, a global positioning system (GPS) receiver, and a wearable computing device, or in any other form factor. Mobile device 700 may include one or more central processing units (“CPUs”) 740, one or more graphic processing units (“GPUs”) 730, a display 720, a memory 760, a communication platform 710, such as a wireless communication module, storage 790, and one or more input/output (I/O) devices 750. Any other suitable component, including but not limited to a system bus or a controller (not shown), may also be included in the mobile device 700. As shown in FIG. 7, a mobile operating system 770 (e.g., iOS, Android, Windows Phone, etc.), and one or more applications 780 may be loaded into memory 760 from storage 790 in order to be executed by the CPU 740. The applications 780 may include a user interface or any other suitable mobile apps for information analytics and management according to the present teaching on, at least partially, the mobile device 700. User interactions, if any, may be achieved via the I/O devices 750 and provided to the various components connected via network(s).

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar with to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

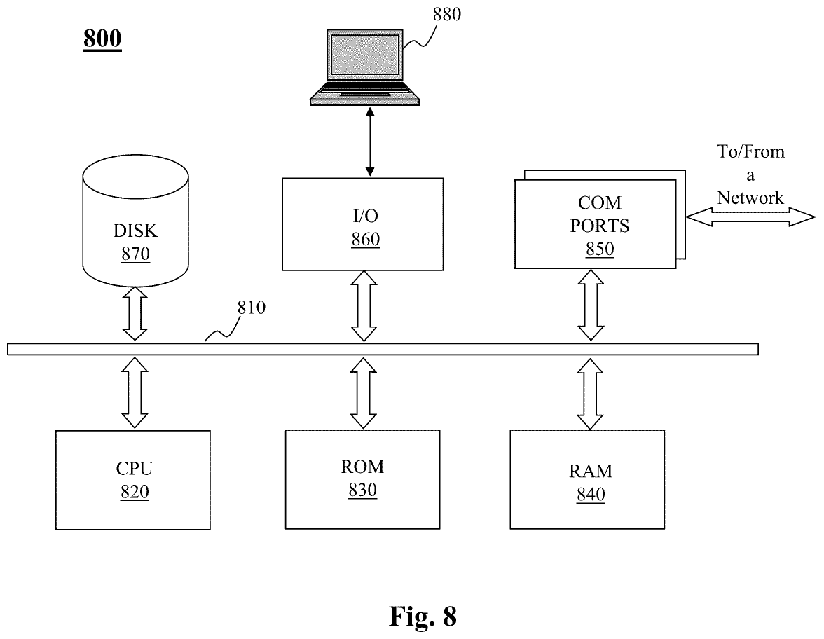

FIG. 8 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 800 may be used to implement any component or aspect of the framework as disclosed herein. For example, the information analytical and management method and system as disclosed herein may be implemented on a computer such as computer 800, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 800, for example, includes COM ports 850 connected to and from a network connected thereto to facilitate data communications. Computer 800 also includes a central processing unit (CPU) 820, in the form of one or more processors, for executing program instructions. The exemplary computer platform includes an internal communication bus 810, program storage and data storage of different forms (e.g., disk 870, read only memory (ROM) 830, or random-access memory (RAM) 840), for various data files to be processed and/or communicated by computer 800, as well as possibly program instructions to be executed by CPU 820. Computer 800 also includes an I/O component 860, supporting input/output flows between the computer and other components therein such as user interface elements 880. Computer 800 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method implemented on at least one processor, a memory, and a communication platform for product recommendation, comprising:
searching for media articles from a media article archive to obtain one or more media articles intended for a user;
for each of the one or more media articles,
determining whether the media article corresponds to commerce content, and
combining, if the media article is commerce content, the media article with information about a product promoted in the media article to generate a combined content with respect to the media article;
generating an integrated content to be sent to the user that includes the combined content for each of the one or more media articles that corresponds to commerce content and each of the one or more media articles that is not commerce content; and
sending the integrated content to the user.

2. The method of claim 1, wherein the step of determining whether the media article corresponds to commerce content comprises:
performing natural language processing on the media article to produce an analysis result;
determining whether the media article is with shopping intention based on the analysis result and a shopping intention model; and
classifying the media article as commerce content if the media article is determined to have the shopping intention.

3. The method of claim 2, further comprising training the shopping intention model prior to the step of determining by:
obtaining a plurality of media articles and respective ground truth commerce content labels;
generating training data based on the media articles and the ground truth labels; and
training, via machine learning, the shopping intention model based on the training data.

4. The method of claim 1, further comprising:
identifying, when the media article corresponds to commerce content, a product keyword corresponding to the product promoted by the media article, wherein
the product keyword is to be used to search for the information about the product including product sources to be provided to the user in the combined content for the media article.

5. The method of claim 4, wherein the step of identifying the product keyword comprises:
obtaining tokens from the media article;
generating a feature vector of the media article based on article embeddings pre-trained via machine learning;
generating, for each of the tokens, a token feature vector based on token embeddings pre-trained via machine learning;
recognizing one or more product keywords, each of which corresponds to a consecutive sequence of tokens;
generating a product keyword feature vector for each of the one or more product keywords based on token feature vectors for tokens in the product keyword;
computing a similarity for each pair of the media article feature vector and one of the one or more product keyword feature vectors;
selecting, based on the one or more similarities, a product keyword having a maximum similarity with the media article to represent the product promoted by the media article.

6. The method of claim 4, wherein the step of combining to generate the combined content comprises:
searching, based on the product keyword representing the product promoted in the media article, one or more product sources that support commercial transactions of the product; and
ranking, based on a pre-specified ranking criterion, the one or more product sources based on metrics associated with the ranking criterion.

7. The method of claim 6, further comprising:
selecting, from the ranked one or more product sources, at least one product source based on a pre-determined condition; and
combining the selected at least one product source with the media article in the combined content in a manner so that when the media article is presented to the user, the at least one product source is made available to the user for accessing relevant information about the product promoted by the media article.

8. Machine readable medium having information recorded thereon for product recommendation, wherein the information, when read by the machine, causes the machine to perform the following steps:
searching for media articles from a media article archive to obtain one or more media articles intended for a user;
for each of the one or more media articles,
determining whether the media article corresponds to commerce content, and
combining, if the media article is commerce content, the media article with information about a product promoted in the media article to generate a combined content with respect to the media article;
generating an integrated content to be sent to the user that includes the combined content for each of the one or more media articles that corresponds to commerce content and each of the one or more media articles that is not commerce content; and
sending the integrated content to the user.

9. The medium of claim 8, wherein the step of determining whether the media article corresponds to commerce content comprises:
performing natural language processing on the media article to produce an analysis result;
determining whether the media article is with shopping intention based on the analysis result and a shopping intention model; and
classifying the media article as commerce content if the media article is determined to have the shopping intention.

10. The medium of claim 9, wherein the information, when read by the machine, further causes the machine to perform the step of training the shopping intention model prior to the step of determining by:
obtaining a plurality of media articles and respective ground truth commerce content labels;
generating training data based on the media articles and the ground truth labels; and
training, via machine learning, the shopping intention model based on the training data.

11. The medium of claim 8, wherein the information, when read by the machine, further causes the machine to perform the step of:
identifying, when the media article corresponds to commerce content, a product keyword corresponding to the product promoted by the media article, wherein
the product keyword is to be used to search for the information about the product including product sources to be provided to the user in the combined content for the media article.

12. The medium of claim 11, wherein the step of identifying the product keyword comprises:
obtaining tokens from the media article;
generating a feature vector of the media article based on article embeddings pre-trained via machine learning;
generating, for each of the tokens, a token feature vector based on token embeddings pre-trained via machine learning;
recognizing one or more product keywords, each of which corresponds to a consecutive sequence of tokens;
generating a product keyword feature vector for each of the one or more product keywords based on token feature vectors for tokens in the product keyword;
computing a similarity for each pair of the media article feature vector and one of the one or more product keyword feature vectors;
selecting, based on the one or more similarities, a product keyword having a maximum similarity with the media article to represent the product promoted by the media article.

13. The medium of claim 11, wherein the step of combining to generate the combined content comprises:
searching, based on the product keyword representing the product promoted in the media article, one or more product sources that support commercial transactions of the product; and
ranking, based on a pre-specified ranking criterion, the one or more product sources based on metrics associated with the ranking criterion.

14. The medium of claim 13, wherein the information, when read by the machine, further causes the machine to perform the step of:
selecting, from the ranked one or more product sources, at least one product source based on a pre-determined condition; and
combining the selected at least one product source with the media article in the combined content in a manner so that when the media article is presented to the user, the at least one product source is made available to the user for accessing relevant information about the product promoted by the media article.

15. A system for product recommendation, comprising:
a content search engine implemented by a processor and configured for searching for media articles from a media article archive to obtain one or more media articles intended for a user;
a product/content integrator implemented by a processor and configured for, with respect to each of the one or more media articles,
determining whether the media article corresponds to commerce content,
combining, if the media article is commerce content, the media article with information about a product promoted in the media article to generate a combined content with respect to the media article,
generating an integrated content to be sent to the user that includes the combined content for each of the one or more media articles that corresponds to commerce content and each of the one or more media articles that is not commerce content, and
sending the integrated content to the user.

16. The system of claim 15, further comprising a commerce content detector implemented by a processor and configured for determining whether the media article corresponds to commerce content comprises:
performing natural language processing on the media article to produce an analysis result;
determining whether the media article is with shopping intention based on the analysis result and a shopping intention model; and
classifying the media article as commerce content if the media article is determined to have the shopping intention.

17. The system of claim 16, wherein the commerce content detector is further configured for training the shopping intention model prior to the step of determining by:
obtaining a plurality of media articles and respective ground truth commerce content labels;
generating training data based on the media articles and the ground truth labels; and
training, via machine learning, the shopping intention model based on the training data.

18. The system of claim 15, further comprising a product keyword extractor implemented by a processor and configured for:
identifying, when the media article corresponds to commerce content, a product keyword corresponding to the product promoted by the media article, wherein
the product keyword is to be used to search for the information about the product including product sources to be provided to the user in the combined content for the media article.

19. The system of claim 18, wherein the step of identifying the product keyword comprises:
obtaining tokens from the media article;
generating a feature vector of the media article based on article embeddings pre-trained via machine learning;
generating, for each of the tokens, a token feature vector based on token embeddings pre-trained via machine learning;
recognizing one or more product keywords, each of which corresponds to a consecutive sequence of tokens;
generating a product keyword feature vector for each of the one or more product keywords based on token feature vectors for tokens in the product keyword;
computing a similarity for each pair of the media article feature vector and one of the one or more product keyword feature vectors;
selecting, based on the one or more similarities, a product keyword having a maximum similarity with the media article to represent the product promoted by the media article.

20. The system of claim 18, wherein the step of combining to generate the combined content comprises:
searching, based on the product keyword representing the product promoted in the media article, one or more product sources that support commercial transactions of the product;
ranking, based on a pre-specified ranking criterion, the one or more product sources based on metrics associated with the ranking criterion;
selecting, from the ranked one or more product sources, at least one product source based on a pre-determined condition; and
combining the selected at least one product source with the media article in the combined content in a manner so that when the media article is presented to the user, the at least one product source is made available to the user for accessing relevant information about the product promoted by the media article.
